(19) United States
(12) Patent Application Publication
(10) Pub. No.: US 2023/0116143 A1
(43) Pub. Date: Apr. 13, 2023

(54) COOKING SYSTEM AND OPERATING METHOD

(71) Applicant: Miele & Cie. KG, Guetersloh (DE)

(72) Inventors: Nils Marius Gehring, Bielefeld (DE); Christoph Mueller, Roedinghausen (DE)

(21) Appl. No.: 17/798,320

(22) PCT Filed: Jan. 13, 2021
(86) PCT No.: PCT/EP2021/050553

§ 371 Date: Aug. 9, 2022

(30) Foreign Application Priority Data
Feb. 18, 2020 (DE) 10 2020 104 130.6

(51) Int. Cl. H05B 6/06; H05B 6/12

(52) U.S. Cl. CPC H05B 6/065; H05B 6/1236; H05B 2213/06; H05B 2213/05

(57) ABSTRACT

A method for operating a cooking system includes: providing at least one cooking hob device, at least one kitchen utensil, and at least one evaluation device, the cooking hob device including at least one placement surface on which to place kitchen utensils and at least one generator device having at least two induction devices for heating the kitchen utensil placed on the placement surface, and the kitchen utensil being heatable by at least one induction device; assigning at least one transmitting device to each of the at least two induction devices of the cooking hob device, the kitchen utensil including at least one receiving device, each transmitting device of the at least one transmitting device emitting at least one electromagnetic signal, at least intermittently, which signal is received by the receiving device of the kitchen utensil when the kitchen utensil is heated by the corresponding induction device.

### CROSS-REFERENCE TO PRIOR APPLICATIONS

This application is a U.S. National Phase application under 35 U.S.C. § 371 of International Application No. PCT/EP2021/050553, filed on Jan. 13, 2021, and claims benefit to German Patent Application No. DE 10 2020 104 130.6, filed on Feb. 18, 2020. The International Application was published in German on Aug. 26, 2021 as WO 2021/164954 A1 under PCT Article 21(2).

### FIELD

The present invention relates to a cooking system and to a method for operating such a cooking system. The cooking system comprises at least one cooking hob device, at least one kitchen utensil, and at least one evaluation device, the cooking hob device at least one placement surface on which to place kitchen utensils and at least two induction devices for heating the kitchen utensil placed on the placement surface. The kitchen utensil is suitable and designed for being heated by means of at least one induction device. Furthermore, at least one transmitting device is assigned to each of the induction devices of the cooking hob device, and the kitchen utensil comprises at least one receiving device. At least one transmitting device emits at least one electromagnetic signal at least intermittently, which signal is received by the receiving device of the kitchen utensil when the kitchen utensil is heated by the corresponding induction device.

### BACKGROUND

The automation of cooking processes and the support of a user are becoming increasingly important in modern household appliances. Ease of use is also playing an increasingly important role.

In the field of cooking hobs, surface induction cooking hobs have become known, for example, which do not comprise cooking zones that are fixed and unambiguously displayed on the placement surface of the cooking hob. The cooking zones or the induction coils located below a pot placed thereon are then each defined as a cooking zone, with only the corresponding induction coils then being activated.

It is advantageous, if not necessary, for the cooking hob to automatically detect where a pot is placed in order to activate the corresponding induction coils. Different systems have become known for this purpose. For example, systems have also become known in which the induction coils emit signals which are detected and further processed by the pot standing thereon.

However, the potential for the detection of the pot position or for supporting a user has not yet been exhausted, and there is a need for further support and better comfort.

For example, the systems mentioned above use a specific type of kitchen utensil that can receive and process the signals emitted by the cooking hob. This requires energy which can be provided inductively during operation of the cooking hob. Before and after a cooking process, however, the power supply is ensured by an accumulator or a battery. Special charging stations are provided for this purpose, or the battery must be replaced after a certain period of time. This is a loss of convenience for the user.

### SUMMARY

In an embodiment, the present invention provides a method for operating a cooking system, comprising: providing at least one cooking hob device, at least one kitchen utensil, and at least one evaluation device, the cooking hob device comprising at least one placement surface on which to place kitchen utensils and at least one generator device having at least two induction devices for heating the kitchen utensil placed on the placement surface, and the kitchen utensil being configured to be heated by at least one induction device; assigning at least one transmitting device to each of the at least two induction devices of the cooking hob device, the kitchen utensil comprising at least one receiving device, each transmitting device of the at least one transmitting device emitting at least one electromagnetic signal, at least intermittently, which signal is received by the receiving device of the kitchen utensil when the kitchen utensil is heated by the corresponding induction device; using at least one sequence of electromagnetic signals to encode a signature for a specific induction device as assignment signals, so that the kitchen utensil is assignable to at least one induction device; and emitting at least one further electromagnetic signal as an information signal at a predetermined temporal distance from at least one of the assignment signals, the predetermined temporal distance from the assignment signal encoding a specific property.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a purely schematic representation in perspective view of a cooking system according to the invention;

FIG. 2 is a purely schematic representation of the provision of assignment signals by means of an induction coil of an induction device;

FIG. 3 is a purely schematic representation of the assignment of a kitchen utensil to specific induction devices or induction coils;

FIG. 4 is a purely schematic representation of the assignment of a kitchen utensil to specific induction devices or induction coils;

FIG. 5 is a purely schematic representation of the assignment of a kitchen utensil to specific induction devices or induction coils;

FIG. 6 is a purely schematic representation of the assignment of a kitchen utensil to specific induction devices or induction coils;

FIG. 7 is a purely schematic representation of the assignment of a kitchen utensil to specific induction devices or induction coils;

FIG. 8 is a purely schematic representation of the assignment of a kitchen utensil to specific induction devices or induction coils;

FIG. 9 is a purely schematic representation of the assignment of a kitchen utensil to specific induction devices or induction coils;

FIG. 10 is a purely schematic representation of the use of a kitchen utensil having two receiving devices in two different orientations on the cooking hob device;

FIG. 11 is a purely schematic representation of the arrangement of a kitchen utensil having two receiving devices on a cooking hob device;

FIG. 12 is a purely schematic representation of the assignment of a kitchen utensil to specific induction devices or induction coils according to a further embodiment;

FIG. 13 is a purely schematic representation of the conversion of ping signatures into identification numbers;

FIG. 14 is another purely schematic representation of the conversion of ping signatures into identification numbers;

FIG. 15 is a purely schematic representation of the assignment of a kitchen utensil to specific induction devices or induction coils by means of an embodiment of the method according to the invention;

FIG. 16 is a purely schematic representation of the assignment of a kitchen utensil to specific induction devices or induction coils by means of a further embodiment of the method according to the invention; and

FIG. 17 is a purely schematic representation of the assignment of a kitchen utensil to specific induction devices or induction coils by means of other embodiments of the method according to the invention.

### DETAILED DESCRIPTION

In an embodiment, the present invention provides an alternative automatic assignment of a pot or the like to one or more induction coils of a cooking hob, which functions reliably and offers further advantages over the prior art.

In an embodiment, the present invention provides a method having the features described herein and by a cooking system having the features described herein. Preferred developments of the invention form the subject matter of the dependent claims. Further advantages and features of the invention can be found in the embodiments.

The method according to the invention is suitable for operating a cooking system comprising at least one cooking hob device, at least one kitchen utensil, and at least one evaluation device. In this case, the cooking hob device comprises at least one placement surface on which to place kitchen utensils and at least one generator device having at least two induction devices for heating the kitchen utensil placed on the placement surface. The kitchen utensil is suitable and designed for being heated by means of at least one induction device. At least one transmitting device is assigned to each of the induction devices of the cooking hob device, and the kitchen utensil comprises at least one receiving device. The transmitting devices each emit at least one electromagnetic signal, at least intermittently, which signal is received by the receiving device of the kitchen utensil when the kitchen utensil is heated by the corresponding induction device. According to the invention, at least one sequence of electromagnetic signals as assignment signals encodes a signature for a specific induction device, so that the kitchen utensil can be assigned to at least one induction device. Furthermore, at least one further electromagnetic signal is emitted as an information signal at a predetermined temporal distance from at least one of the assignment signals, with the distance from the assignment signal encoding a specific property.

The evaluation device is in particular in contact or in operative connection with the cooking hob device and/or the kitchen utensil, with the evaluation device preferably being part of the cooking hob device or being able to be integrated into it. Depending on the configuration, however, the evaluation device can also be assigned to the kitchen utensil and/or preferably provided as a separate device which is connected to the kitchen utensil and/or the cooking hob device. For example, the function of the evaluation device can also be provided by a central control device for a plurality of household appliances, which control device can separate from a household appliance or integrated in a household appliance.

The kitchen utensil preferably comprises at least one communication device by means of which information and/or the received assignment signals can be forwarded to the evaluation device, so that the evaluation unit which can further process the assignment signals received from the kitchen utensil is in operative connection with the evaluation device. Such a communication device can be realised, for example, via Bluetooth, WLAN, radio or the like, or can comprise communication means of this type.

For the general method for assigning kitchen utensils to a cooking hob device or a heating element or a heating zone of a cooking hob device, and for the structural configuration of kitchen utensil and cooking hob device, the content of the as yet unpublished patent application EP19191642.8 is incorporated into this application by reference.

The generator device comprises in particular the induction devices which each preferably comprise at least one induction coil by means of which the kitchen utensil can be excited or heated. The generator device can preferably also comprise other components of the power electronics and/or be connected thereto.

According to the invention, the information signal encodes at least one property. This property can in particular be at least one state of the cooking hob device, of the generator, and/or of the induction devices. It is particularly advantageous if the operating mode of the cooking hob device, of the generator, and/or of the induction devices is transmitted as a property. The type of cooking hob device used can preferably be transmitted additionally or exclusively as a property. In particular, the information that a fully integrated cooking hob having a placement surface having specific properties or parameters is being used can be transmitted. The cooking process can then preferably be adjusted correspondingly by the kitchen utensil. However, a property is in particular also the temperature, at least one operating parameter, a button status, the food to be prepared and/or the like.

The property is transmitted by the information signal. In this case, specific properties and/or property combinations are stored in the kitchen utensil, the evaluation device, and/or the cooking hob device, which are detected as an encoded property depending on the distance between the information signal and an assignment signal.

The at least one information signal can preferably be sent before or after the assignment signals or before or after the assignment signature. Depending on the configuration, the information signal can also be sent within the assignment signature. Depending on the configuration, a suitable number of electromagnetic signals can then preferably be selected in order to be able to distinguish between the assignment signals and the information signal or signals, for example via defined flanking signals or electromagnetic signals. The information signal is preferably sent before the first assignment signal or after the last assignment signal.

In all configurations, it is preferred that at least one transmitting device is provided by at least one induction device. In this way, the design effort is minimised, since already existing components can be used as the transmitting device.

Furthermore, in all configurations, at least one receiving device preferably comprises at least one coil. A receiving device for the signals emitted by the transmitting device can thus be provided in a simple manner.

An electromagnetic signal is in particular at least one electromagnetic excitation which is output or sent by the transmitting device.

The method according to the invention offers many advantages. It is a significant advantage that, in addition to encoding the pot position, further information can be transmitted from the cooking hob to the kitchen utensil via the electromagnetic signals.

Depending on the configuration, a speed-optimised data transmission can take place, for example, or the frequency of data transmission can be adjusted. Known kitchen utensils that can communicate with a cooking hob device, a so-called system cooking utensil, usually always sends information such as process data, TE signature ping, temperature, button status, etc. at the same interval, even if this could be longer for some applications. For example, in a preparation mode of the cooking hob and/or in a residual heat mode of the system cooking utensil, longer intervals are sufficient than active in operation when an “exact” temperature is set in the kitchen utensil or, for example, milk has to be prevented from boiling over. In the case of milk, for example, it is extremely important that a large amount of process data is transmitted relatively frequently and quickly from the system cooking utensil to the process engineering so that the process engineering can prevent the milk from boiling over quickly. The system utensil needs its own power supply. The process energy can usually be provided by the induction coils by induction. However, there are also operating states without active charging of the system cooking utensils. Such operating states are, for example, the preparation mode and/or use of residual heat. The energy consumption of the electronics in the system cooking utensil is significantly reduced by speed-optimised data transmission or by adjusting the frequency of signal transmission. As a result, the recharging of an accumulator can be significantly accelerated, the frequency can be reduced, and/or the service life of a battery is considerably extended. This brings an enormous increase in comfort for the user.

In addition, depending on the configuration, situation-optimised data transmission can take place. In this case, for example, an application is conceivable if the induction devices are not installed in a classic cooking hob with a placement surface made of glass ceramic, but are installed in a so-called fully integrated cooking hob. The induction devices can then be installed, for example, under and/or in a ceramic plate or under or in a conventional worktop. It is the practical to send, as an information signal or property, the fully integrated installation of the generator device underneath, for example, a ceramic plate to the kitchen utensil. This information can then be detected by the system cooking utensil and sent to the process engineering. This in turn then limits, for example, depending on the surface, the maximum temperature and/or the ΔT/t, and/or other parameters or values.

Furthermore, depending on the configuration, selective data transmission can take place. This is expedient, for example, when the kitchen utensil or the energy store or accumulator of the kitchen utensil is being charged. In this case, it is sufficient that the current state of charge and the software version are transmitted. If the software version is not up-to-date and the state of charge is sufficient, the process engineering circuit board in the cooking hob device carries out an update, depending on the configuration. In this case, too, the power consumption of the electronics in the kitchen utensil can be reduced.

All three applications described above preferably provide energy-optimised data transmission. Depending on the application, smaller charging systems for the kitchen utensil can then be provided for lower power consumption.

In particular, an operating state with an empty accumulator or energy store is avoided. The operation of the kitchen utensil can thus be generally ensured at all times. This also offers an advantage of convenience for the user.

In addition, the intervals for replacing the accumulator or battery can be significantly extended or replacements can even be avoided.

In addition, as already described, the transmission of specific properties, depending on the configuration, allows operation on alternative surfaces to the glass ceramic, in particular without adjusting the generator or the kitchen utensil.

The electromagnetic signals of the individual transmitting devices are preferably emitted with a predetermined temporal offset and/or the assignment signals and/or the information signals of the individual induction devices comprise different predetermined sequences of electromagnetic signals as a signature, so that the evaluation device can assign the electromagnetic signals detected by the receiving device to the individual induction devices and thus carry out an assignment of the kitchen utensil to at least one induction device and can assign a property. In this way, an unambiguous assignment can also take place with a plurality of coils.

Particularly preferably, at least one interval and/or frequency of the transmission of electromagnetic signals depend(s) at least intermittently on at least one property detected from at least one information signal. For example, by transmitting a specific operating state of the cooking hob device, of the generator device and/or of the induction device, the frequency of signal transmission can be reduced, for example in the preparation mode and/or when using residual heat. For example, when boiling milk, the food can be transmitted as a property, thereby preferably resulting in more frequent signal transmission.

In advantageous configurations, at least one interval and/or frequency of the transmission of electromagnetic signals depend at least intermittently on the energy state of at least one energy store. This ensures a type of emergency operation, for example if the state of charge of the energy store, such as an accumulator, would no longer be sufficient for the entire cooking process with normal data transmission.

In expedient developments, at least one cooking process is adjusted on the basis of at least one property detected from at least one information signal. For example, the cooking process can be adjusted depending on the worktop in fully integrated cooking hobs or through other properties such as the food.

The assignment signals of the individual induction devices preferably comprise the same predetermined sequences of electromagnetic signals which are distinguished via the temporal offset. In this way, an unambiguous assignment of induction devices to a kitchen utensil can take place.

Particularly preferably, at least two generator devices are provided, and the assignment signals of the individual induction devices each comprise a predetermined sequence of at least three electromagnetic signals as a signature, with a first distance between the first electromagnetic signal and the second electromagnetic signal encoding the generator device and a second distance between the second electromagnetic signal and the third electromagnetic signal encoding the induction device of the corresponding generator device, or vice versa. In this way, an unambiguous assignment of the generator device and the induction device to a kitchen utensil can take place.

In advantageous developments, the first distance increases from generator device to generator device, and the second distance decreases from induction device to induction device of a corresponding generator device.

The information signal is preferably a fourth electromagnetic signal at a third distance from the third electromagnetic signal, with the third distance encoding a property of the cooking hob device, of at least one generator device, and/or of at least one induction device. Depending on the configuration, however, the information signal can also be emitted as the first signal, in which case the distances between the assignment signals are then configured correspondingly.

Particularly preferably, at least two induction devices of at least one generator device simultaneously emit an electromagnetic signal at least once. In this way, even more information can be transmitted in a preferably 4-digit binary code in which up to 16 possible modes are then preferably possible.

Preferably, the received electromagnetic signals are translated into an unambiguous identification number which corresponds to the covering of specific induction devices and/or corresponds to a specific property.

In expedient developments, the received predetermined sequences of electromagnetic excitations of the corresponding induction devices are input into a common time curve, with the identification number being determined on the basis of the signal pattern.

The intensity of at least one electromagnetic signal is preferably taken into account.

Particularly preferably, the intensity of the electromagnetic signals is taken into account in order to infer the covering of individual induction devices by a kitchen utensil.

The cooking system according to the invention comprises at least one cooking hob device, at least one kitchen utensil, and at least one evaluation device. In this case, the cooking hob device comprises at least one placement surface on which to place kitchen utensils and at least two induction devices for heating the kitchen utensil placed on the placement surface. The kitchen utensil is suitable and designed for being heated by means of at least one induction device, with at least one transmitting device being assigned to each of the induction devices of the cooking hob device. The kitchen utensil comprises at least one receiving device, the transmitting devices each being suitable and designed for emitting at least one electromagnetic signal at least intermittently, and the receiving device being suitable and designed for receiving an electromagnetic signal when the kitchen utensil is heated by the corresponding induction device. Furthermore, the evaluation device is suitable and designed for detecting a signature for a specific induction device from at least one sequence of electromagnetic signals as assignment signals, so that the kitchen utensil can be assigned to at least one induction device. In addition, the evaluation device is suitable and designed for detecting at least one property of the cooking hob device, of a generator device, and/or of the corresponding induction device as an information signal from at least one further electromagnetic signal at a predetermined temporal distance from at least one of the assignment signals.

The cooking system according to the invention also offers the advantages that have already been explained above for the method according to the invention.

The kitchen utensil preferably comprises at least one energy store. In this case, such an energy store can be, for example, a permanently installed and/or replaceable battery and/or a permanently installed and/or replaceable accumulator. Depending on the configuration, other energy stores can also be used in a practical manner. In particular when using accumulators, they can preferably be charged inductively by the induction devices.

Particularly preferably, the interval and/or the frequency of the emission of the electromagnetic signals depend(s) on a detected property and/or the energy state of the energy store. This is particularly useful in preparation mode and/or when using residual heat. Depending on the application, an adjusted transmission of signals protects the energy store by a reduced transmission of signals and/or optimises processes by transmitting data more frequently.

A further method according to the application is suitable for operating a cooking system comprising at least one cooking hob device, at least one kitchen utensil, and at least one evaluation device. The cooking hob device has at least one placement surface on which to place kitchen utensils and at least one generator device having at least two induction devices for heating the kitchen utensil placed on the placement surface. The kitchen utensil is suitable and designed for being heated by means of at least one induction device. Furthermore, at least one transmitting device is assigned to each of the induction devices of the cooking hob device, and the kitchen utensil comprises at least one receiving device. The transmitting devices each send at least one assignment signal, at least intermittently, which signal is received by the receiving device of the kitchen utensil when the kitchen utensil is heated by the corresponding induction device. According to the invention, the assignment signals of the individual transmitting devices are emitted with a predetermined temporal offset, so that the evaluation device can assign the assignment signals detected by the receiving device to the individual induction devices and thus carry out an assignment of the kitchen utensil to at least one induction device. Additionally or alternatively, the assignment signals of the individual induction devices can comprise different predetermined sequences of electromagnetic excitations as a signature.

The evaluation device is in particular in contact or in operative connection with the cooking hob device and/or the kitchen utensil, with the evaluation device preferably being part of the cooking hob device or being able to be integrated into it. Depending on the configuration, however, the evaluation device can also be assigned to the kitchen utensil and/or preferably provided as a separate device which is connected to the kitchen utensil and/or the cooking hob device. For example, the function of the evaluation device can also be provided by a central control device for a plurality of household appliances, which control device can separate from a household appliance or integrated in a household appliance.

The kitchen utensil preferably comprises at least one communication device by means of which information and/or the received assignment signals can be forwarded to the evaluation device, so that the evaluation unit which can further process the assignment signals received from the kitchen utensil is in operative connection with the evaluation device. Such a communication device can be realised, for example, via Bluetooth, WLAN, radio or the like, or can comprise communication means of this type.

The generator device comprises in particular the induction devices which each preferably comprise at least one induction coil by means of which the kitchen utensil can be excited or heated. The generator device can preferably also comprise other components of the power electronics and/or be connected thereto.

This method also offers many advantages. It is a significant advantage that an automatic detection of the pot position or the position of the kitchen utensil on the cooking hob device or on the placement surface of the cooking hob device can be provided by the method according to the invention. In this way, it can be detected which induction devices or which induction coils are covered by a kitchen utensil.

It is particularly advantageous that the temporally offset transmission of assignment signals creates the option of assigning the assignment signals to a specific induction device. Thus, a specific assignment to a specific coil can also take place with the same assignment signal and/or with the same signal components due to the temporal offset.

In addition, it is also possible to detect that a kitchen utensil is not only standing on an induction coil or is being operated by an induction coil, but that, for example, a kitchen utensil only partially or completely covers a plurality of induction coils. It is thus possible to detect the use of a plurality of induction devices or induction coils for a kitchen utensil.

All of these advantages also result if the induction coils or induction devices emit predetermined signal sequences as a signature, which are unique for each induction device, so that the covering of specific induction devices can be deduced.

The assignment signals of the individual induction devices preferably comprise the same predetermined sequences of electromagnetic excitations which are distinguished via the temporal offset. A simple assignment signal can be provided via signals of this type, for example ping signals. Such an electromagnetic excitation or such a ping signal can preferably be provided by at least one range of the electromagnetic excitation of an induction device, with a specific portion or range or value of the half-waves used for the excitation being used as the signal.

If the assignment signals of the individual induction devices comprise different predetermined sequences of electromagnetic excitations as a signature, an unambiguous assignment to a coil can preferably be made via the type of electromagnetic signal of the individual coils. The number of electromagnetic signals in the sequence or the number of ping signals and also the distance between the ping signals can be used as a distinguishing feature for predetermined sequences of electromagnetic excitations. Even with different signal sequences for the individual induction devices, it can be achieved via the temporal offset that the signals from the individual coils do not overlap and can be evaluated separately.

At least two generator devices are preferably provided, and the assignment signals of the individual induction devices each comprise a predetermined sequence of at least three electromagnetic excitations as a signature. The first distance between the first electromagnetic excitation and the second electromagnetic excitation encodes the generator device of the corresponding induction device, and a second distance between the second electromagnetic excitation and the third electromagnetic excitation encodes the corresponding induction device of the corresponding generator device, or vice versa. In this way, even in the case of a cooking hob device having a plurality of generators, an unambiguous assignment of the individual induction devices can take place. The signal sequence contains the information about the corresponding generator device and about the corresponding induction device.

Preferably, the first distance increases from generator device to generator device, and the second distance decreases from induction device to induction device of a corresponding generator device. Such a systematic approach to the signal signatures allows a particularly advantageous, precise, and distinct encoding of the individual induction devices to take place, even if a plurality of induction devices are covered.

In advantageous configurations, the electromagnetic excitations received are translated into an unambiguous identification number which corresponds to the covering of specific induction devices. Since the ping signature is translated into a specific identification number that is unique to the covering of induction devices, information can be transmitted with a very small data volume.

When translating the ping signals or the electromagnetic excitations into an identification number, the binary adding method can be used, for example and preferably, in order to convert the presence of signals or the absence of signals into a specific number. The resulting identification numbers are unique to a specific signature or combination signature. In preferred configurations, these identification numbers can be stored in a list, for example, with a specific, for example eight-digit identification number being assigned a sequential number, for example a two-digit number.

The entire processing of the data preferably takes place in a chip in the kitchen utensil. A table of the individual identification numbers a concordance list for the 2-digit numbers can be stored on this chip, for example. In this way, an information transmission can take place the from the kitchen utensil to the cooking hob with an extremely low data volume. This can take place, for example, via Bluetooth or another suitable data interface.

Particularly preferably, the received predetermined sequences of electromagnetic excitations of the corresponding induction devices are input into a common time curve, with the identification number being determined on the basis of the resulting signal pattern. In this case, the received signals are brought into an overall context with all received signals, regardless of their affiliation with a specific induction device. Depending on the configuration, the uniqueness of the individual signatures results in a unique signature composition which can be translated into a specific identification number for the corresponding combination of specific induction devices or individual induction devices.

In expedient developments, the intensity of at least one assignment signal is taken into account. In this context, intensity is understood to be, in particular, the amplitude of electromagnetic radiation or of the electromagnetic signal measured by the receiving device. In the case of a predetermined maximum amplitude, a complete covering of the corresponding induction device can be assumed. In the case of lower amplitudes, the corresponding induction devices are only partially covered in accordance with the amplitude.

In expedient configurations, the intensity of the assignment signals is then taken into account in order to infer the covering of individual induction devices by a kitchen utensil. It is thus possible to use the received assignment signals to detect the relevant induction devices for a kitchen utensil that has been placed thereon, and a percentage covering of the individual induction devices or individual induction coils can be detected via the intensity or amplitude of the assignment signal. It is thus possible to infer via the reception of a signal that a coil is covered by a kitchen utensil, and it is possible to infer the extent of the covering from the amplitude.

At least one transmitting device is preferably provided by at least one induction device. In a configuration of this type, in particular at least one induction coil of at least one induction device is used as the transmitting device. By using an induction coil or a primary coil as the transmitting device, a transmitting device is provided without major design complexity.

Particularly preferably, at least one receiving device comprises at least one coil. A coil of this type can be arranged in particular in the base of the kitchen utensil. The configuration of the receiving device as a coil or as a secondary coil allows a simple technical implementation of a receiving device.

In expedient developments, at least two receiving devices are provided in the kitchen utensil. Either two separate receiving devices can be provided or just one receiving device with two receivers, the signals of the two receivers then preferably being able to be evaluated differently or separately. By providing two separate receiving devices or at least two receivers that can be evaluated separately, it is possible to detect the orientation of the kitchen utensil and also movements of the kitchen utensil on the placement surface, with the translational movement of the kitchen utensil over the placement surface also being possible in principle with just one receiving device.

At least one orientation of the kitchen utensil on the placement surface is preferably detected. This is possible in particular if at least two receiving devices are provided in the kitchen utensil.

In particular when two or more induction devices are covered by the kitchen utensil, at least one operating parameter of at least one induction device is preferably set on the basis of the orientation of the kitchen utensil. In this case, two different cooking regions can be provided, for example in the case of a roaster, by providing two receiving devices, for example in the base of the roaster. For example, it can be detected via the two receiving devices which of the two coils is pointing in the direction of the user. In a preferred configuration of a special kitchen utensil, for example, it can be achieved that with a specific orientation of the kitchen utensil on the cooking hob device, a hot searing zone is provided at the front and a somewhat cooler warming zone is provided at the rear. If the pot is placed on the cooking hob in a different orientation, uniform heating of the kitchen utensil can be provided, for example. The applicant reserves the right to also claim a kitchen utensil with at least two receiving devices.

At least one movement of the kitchen utensil on the placement surface is preferably detected. The movement of the kitchen utensil over the placement surface can be detected both with a coil and with a plurality of receiving devices in the kitchen utensil.

The movement of the kitchen utensil on the placement surface preferably comprises at least one translational and/or at least one rotational movement. For example, it can be detected whether the kitchen utensil is being pulled away from the original position thereof and/or whether the kitchen utensil is being rotated in the original position thereof. Depending on the configuration, specific operating parameters can be changed or set by both actions. A rotational movement is preferably detected in the case of kitchen utensils which comprise two receiving devices.

At least one operating parameter of the cooking hob device is preferably set on the basis of the movement. For example, by pulling a kitchen utensil away from the induction device currently being used, the cooking hob device can be switched off automatically, at least for this kitchen utensil. It is also possible, for example, for the power of the corresponding induction device to be changed by rotating the kitchen utensil on the spot. For example, depending on the configuration, the power can be increased by rotating clockwise, while rotating counter clockwise causes a reduction in power.

Preferably, at least one operating parameter set for a kitchen utensil of at least one induction device is transmitted to the then relevant induction device or the relevant induction devices when the kitchen utensil is moved. By moving the pot on the placement surface, the adjustment for a kitchen utensil can be transmitted to another induction device if the pot is pushed to another location, for example due to lack of space or for other reasons.

The transmitting devices preferably send the assignment signals during operation of at least one induction device. In a configuration of this type, for example, the electromagnetic radiation used to heat the kitchen utensil or regions thereof can also be used as the assignment signal.

In other expedient configurations or additionally, the transmitting devices also send the assignment signals when the cooking hob device or the induction devices are not in operation. In particular in a method of this type, relatively little electromagnetic radiation is used, in which case a pot position can also be detected when the cooking hob device is switched off or none of the induction devices is in operation.

A display device on the kitchen utensil is preferably activated via the assignment signals and/or a change in the assignment signals. For example, the display of parameters or instructions to the user and/or the monitoring of a cooking process can be supported. The applicant reserves the right to also claim a kitchen utensil of this type.

All of the features described for this method can preferably be combined individually and/or in combination with other features with the method according to the invention or preferred developments thereof.

Another cooking hob system according to the application comprises at least one cooking hob device, at least one kitchen utensil and at least one evaluation device, the cooking hob device comprising at least one placement surface on which to place kitchen utensils and at least two induction devices for heating the kitchen utensil placed on the placement surface. The kitchen utensil is suitable and designed for being heated by means of at least one induction device. At least one transmitting device is assigned to each of the induction devices of the cooking hob device, with the kitchen utensil comprising at least one receiving device. The transmitting devices are each suitable and designed for emitting at least one assignment signal at least intermittently, with the receiving device being suitable and designed to receive these signals when the kitchen utensil is heated by the corresponding induction device. According to the invention, the evaluation device is suitable and designed for carrying out an assignment of the kitchen utensil to the at least one induction device via the assignment signals emitted by the transmitting device with a temporal offset and detected by means of the receiving device and/or via the detected signatures from the predetermined sequences of electromagnetic excitations of the individual assignment signals of the individual induction devices.

This cooking system also offers the advantages already explained above for the method according to the invention.

At least one transmitting device is preferably provided by at least one induction device or at least one induction coil of the at least one induction device. Thus, at least one transmitting device is preferably provided by at least one primary coil.

Particularly preferably, at least one receiving device comprises at least one coil or at least one secondary coil.

In expedient configurations, at least two receiving devices are provided in the kitchen utensil. In this case, preferably either two separate receiving devices are provided and/or one receiving device with at least two receivers that can be evaluated separately.

In expedient configurations, the kitchen utensil comprises at least one display device which can be activated or supplied with information in particular by means of at least one assignment signal and/or at least one change in the assignment signal.

All the features described for this cooking system can preferably be combined individually and/or in combination with other features with the cooking system according to the invention or preferred developments thereof.

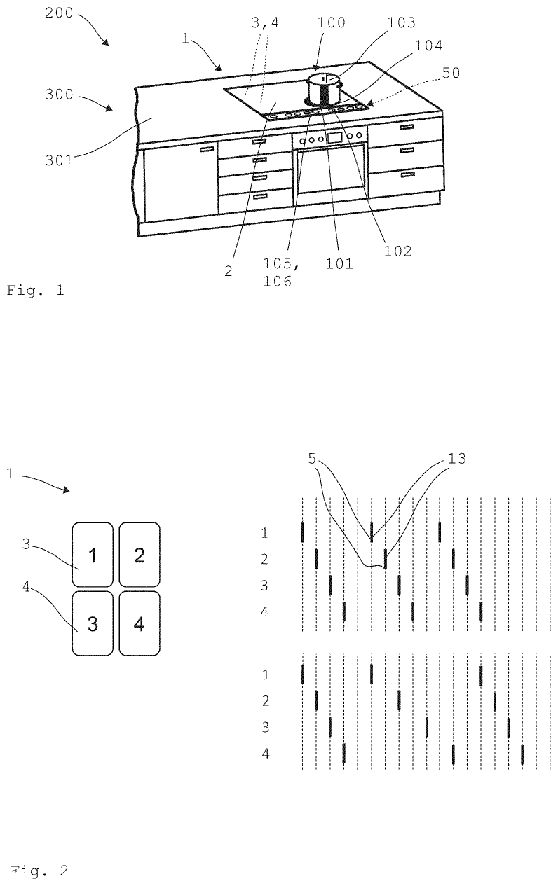

FIG. 1 is a purely schematic perspective view of a cooking system 200 according to the invention. The cooking system 200 in the embodiment shown here comprises a cooking hob device 1 which is built into the worktop 301 of a kitchen unit 300.

The cooking hob device 100 comprises a placement surface 2 on which kitchen utensils 100 can be placed. In the embodiment shown here, a plurality of induction devices 3 are arranged uniformly below the placement surface 2, by means of which induction devices the kitchen utensil 100 standing on the placement surface 2 can be heated. For the sake of clarity, only two induction devices 3 are shown in FIG. 1.

Furthermore, the cooking system 200 comprises an evaluation device 50 which is integrated into the cooking hob device 1 in the embodiment shown here.

In the embodiment shown here, the cooking hob device 1 comprises a plurality of transmitting devices 4 for transmitting at least one assignment signal 5 via which the position of the kitchen utensil 100 on the placement surface 2 can be automatically detected in conjunction with the kitchen utensil 100 and the evaluation device 50. An assignment of the induction devices 3 to a kitchen utensil 100 standing on the placement surface 2 is thus possible.

In the embodiment shown here, the transmitting devices 4 are integrated into the induction devices 3 or are provided by the induction coils of the induction devices 3.

The kitchen utensil 100 has a receiving device 101 here, which in the embodiment shown is also provided by a coil 102 on or in the base 104 of the kitchen utensil 100. Depending on the configuration, more than one receiving device 101 and/or a plurality of receivers can also be provided.

In the method according to the invention, the transmitting devices 4 transmit assignment signals 5 at least intermittently, which signals are received or detected by means of the receiving device 101 or, depending on the configuration, by a plurality of receiving devices 101 of the kitchen utensil 100 when the kitchen utensil 100 is arranged on the placement surface 2 such that it is heated by these induction devices 3.

The assignment signals 5 received and/or a further-processed signal are transmitted to the evaluation device 50 by means of a suitable communication device (not shown in detail). The communication device can be integrated into the kitchen utensil 100 or, depending on the configuration, can also be provided as a separate assembly which can access the receiving device 101 of the kitchen utensil 100 via suitable functions.

The kitchen utensil 100 can also comprise a display device 103 which is activated by the assignment signals 5, by changes in the assignment signals, or in some other way. It is thus also possible to transmit information to the kitchen utensil via the assignment signals and to display said information on the display device 103.

In order to ensure the power supply of the components for signal processing of the kitchen utensil, an accumulator 106 is provided as energy store 105 in the embodiment shown here. In the embodiment shown, said accumulator can be charged in a charging station when not in use. The power supply takes place in this case during operation of the cooking hob device 1 mainly via the induction devices 3.

FIG. 2 shows the functioning of the method according to the invention in a purely schematic manner Four induction devices 3 of a cooking hob device 1 are shown, with the induction coils of the induction devices 3 functioning as transmitting devices 4.

Below the induction devices 3, FIG. 2 shows the half-waves which are emitted by the induction devices 3 or the induction coils of the induction devices 3 for heating a kitchen utensil 100. In addition to the induction devices, it is shown in a purely schematic manner that a range of these half-waves or a specific voltage value of the electromagnetic radiation is used as an assignment signal 5.

Two examples of assignment signals 5 for the induction devices 3 are shown below the row of half-waves. The first rows 1-4 show that a temporally offset assignment signal 5 is emitted by the four induction devices 3 or the 4 transmitting devices 4, with the pattern of the assignment signals being identical. So-called ping signals are provided here, with a transmission pattern comprising three signals at a specific temporal distance.

However, due to the temporal offset when emitting the assignment signals 5, an unambiguous distinction can be made between the individual induction devices 3. The temporal offset in the embodiment shown here is approximately 10 ms. However, the temporal offset can also be selected differently in suitable ranges.

The bottom four lines show in a purely schematic manner that the assignment signals 5, which are also now provided as ping signals, do not have the identical structure.

A signal structure is formed here via the distance between the individual signals of the individual transmitting devices, which signal structure is different and unambiguous for each induction device. Thus, a specific induction device 3 or a specific transmitting device 4 can be inferred solely via the structure of the assignment signals or the ping signals.

Due to the temporal offset when emitting the assignment signals 5, there is no common detection of different signals, so that the signal from different induction devices 3 or transmitting devices 4 can always be unambiguously distinguished by the time component.

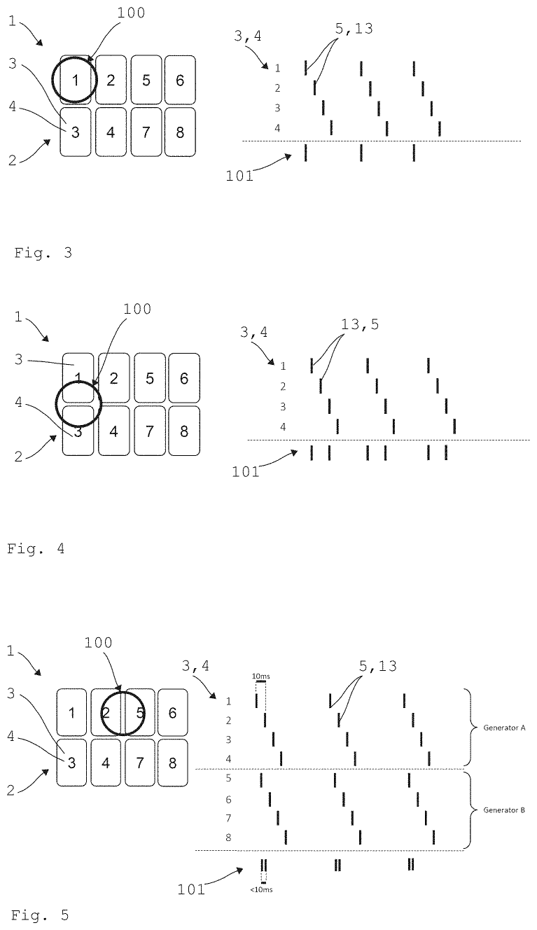

FIGS. 3 and 4 show in a purely schematic manner the assignment signals 5 received from a kitchen utensil, with a kitchen utensil 100 only covering the first induction coil 3 in the embodiment shown here. The signal received and evaluated in the evaluation device 50 corresponds to the signal structure and the time component of first induction device 3. In this way, the position of the kitchen utensil 100 on the placement surface 2 can be unambiguously inferred.

FIG. 4 shows that the kitchen utensil 100 is standing on the first and the third induction device 3. The corresponding signal is shown to the right, in which case an assignment to specific induction devices 3 can be made unambiguously via the signal structure and the temporal reception of the corresponding assignment signals 5 by the receiving device 101, so that the exact position of the kitchen utensil 100 on the placement surface 2 detects by the evaluation device 50.

FIGS. 5 and 6 show in a purely schematic manner one option for distinguishing the assignment signals 5 from more than four induction devices 3 or the induction devices of a plurality of generators.

The induction devices 3 are divided into 2 groups of four, with the distinction between the first and the second group being made by a phase shift. In this case, via a phase shift of 120° has been achieved between the induction devices 3 of a first generator A and those of a second generator B.

In FIG. 5, two induction devices 3 are covered by a kitchen utensil. The assignment signals 5 received by means of the receiving device 101 of the kitchen utensil 100 and transmitted to the evaluation device 50 are shown next to the induction devices 3.

FIG. 6 shows the same arrangement as in FIG. 5, with the placed kitchen utensil 100 now covering four induction devices 3. The data or signals received by the receiving device 101 of the kitchen utensil 100 and transferred to the evaluation device 50 are shown again.

FIGS. 7 to 9 show in a purely schematic manner that the amplitude or the intensity of the received assignment signal 5 can contribute to the optimisation of the position detection.

In this case, FIG. 7 shows that a kitchen utensil 100 is predominantly standing on the first induction device 3. Only a significantly smaller part of the kitchen utensil 100 also covers the second induction device 3.

The percentage covering of induction devices 3 by a kitchen utensil 100, the level or amplitude or intensity of the assignment signals 5 received can be unambiguously determined. The assignment signal 5 received from the first induction device 3 is significantly higher than that from the second induction device 3. Thus, the percentage covering of the corresponding induction device can be inferred from a received strength or amplitude or intensity of an assignment signal 5 via the covering of an induction device 3.

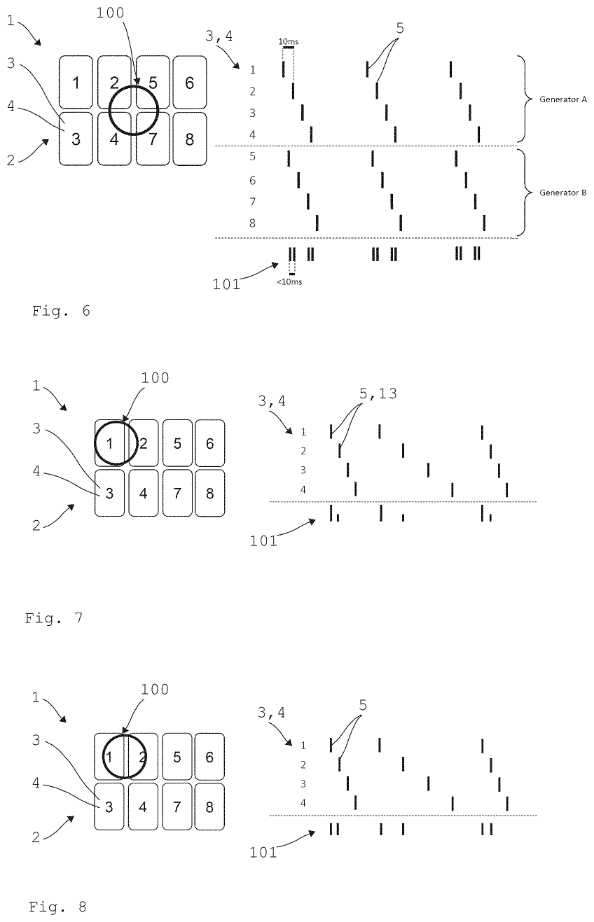

FIG. 8 shows the same arrangement as in FIG. 7, with the first two induction devices 3 being uniformly covered by a kitchen utensil 100. The corresponding assignment signal 5 is shown next to it, the same amplitude or signal level of the assignment signals 5 indicating approximately 50% covering of the respective induction devices 3 in each case.

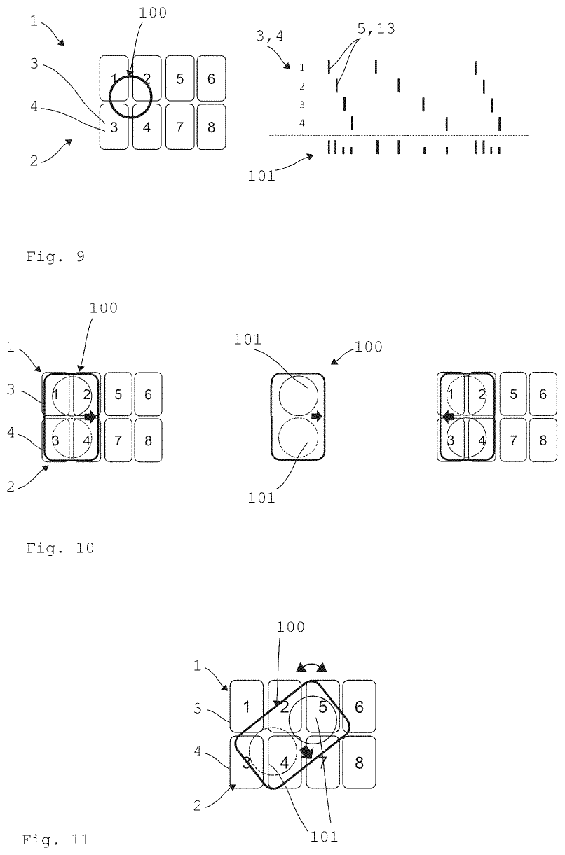

As shown in the two previous figures, FIG. 9 shows that the percentage covering can be inferred via the level or the amplitude or the intensity of an assignment signal 5. In this case, the first four induction devices 3 are covered differently by a kitchen utensil 100, with the first and second induction devices 3 being equally covered and the third and fourth induction devices 3, with the first and second induction devices being covered to a greater extent than the third and the fourth. The corresponding received assignment signals 5 are shown to the right.

FIG. 10 shows in a purely schematic manner that a kitchen utensil 100 can also have more than one receiving device 101. Then, in addition to the position on the placement surface 2 of a cooking hob device 1, the orientation of the kitchen utensil 100 on the placement surface 2 can also be detected.

The arrow indicates in a purely schematic manner the orientation in which the kitchen utensil 100 is located on the placement surface 2. The kitchen utensil 100 is shown again in the middle in a purely schematic manner in order to show the two receiving devices 101 again.

For example, depending on the configuration, different regions or portions of a kitchen utensil 100 can be assigned a different operation. Depending on the orientation of the kitchen utensil 100 on the placement surface 2 or depending on which receiving device 101 is facing or facing away from the user, different cooking zones are provided here.

For example, in the representation on the left, it is possible for another searing zone to be provided at the front or facing the user, with a warming zone being provided in the rear region of the kitchen utensil 100.

If the kitchen utensil 100 is now placed with a different orientation, rotated by 180° in the embodiment shown here, uniform heating of the kitchen utensil 100 can be provided, for example.

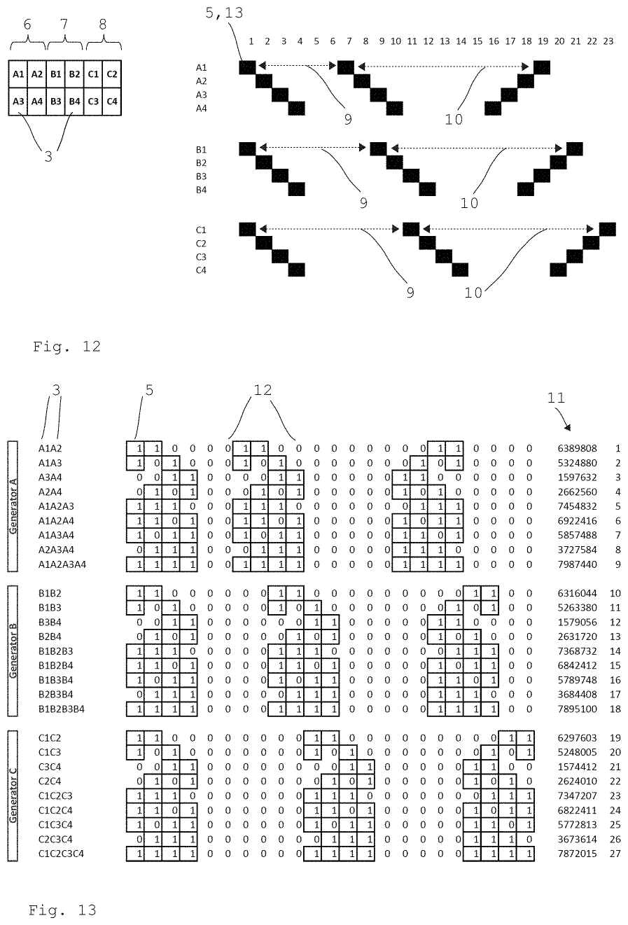

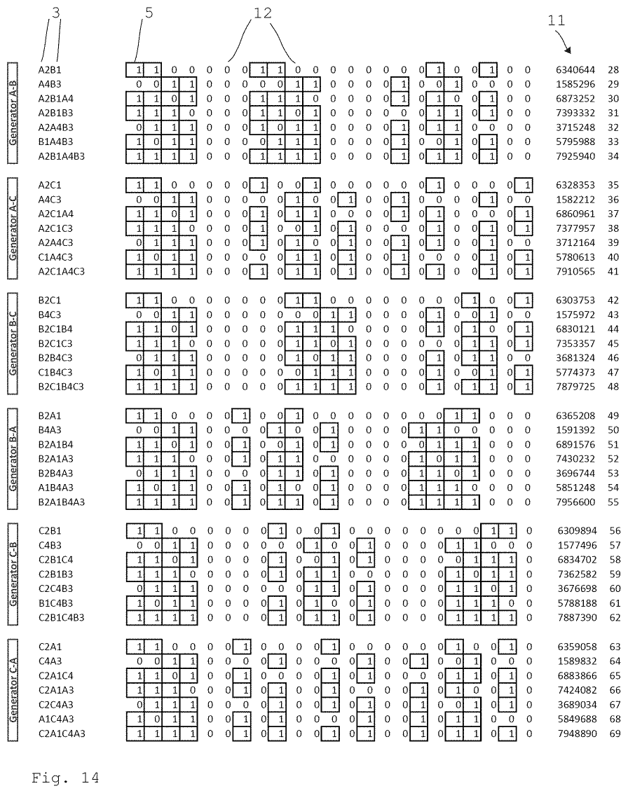

FIG. 11 shows in a purely schematic manner that specific operating parameters, for example, can be set by moving the kitchen utensil 100 on the placement surface 2 of a cooking hob device 1. This is possible both with just one receiving device 101 and with a plurality of receiving devices 101.

If, for example, only one receiving device 101 is provided for the kitchen utensil 100, translational movements can be detected and, for example, be converted into control signals. It is thus possible, for example, for this induction device 3 to be switched off by pulling a kitchen utensil 100 away from an induction device 3.

Depending on the configuration, it is also possible to transmit the operating parameters set for an induction device 3 to this induction device 3 by pulling the kitchen utensil 100 away to another induction device 3.

In particular, if at least two receiving devices 101 are provided, rotational movement on the placement surface 2 can also be detected, so that, for example, rotating the kitchen utensil 100 changes operating parameters. For example, rotating the kitchen utensil 100 clockwise can increase the power, while rotating it counter clockwise reduces the power.

Other adjustments can also be expediently made via the movement and/or the orientation of the kitchen utensil.

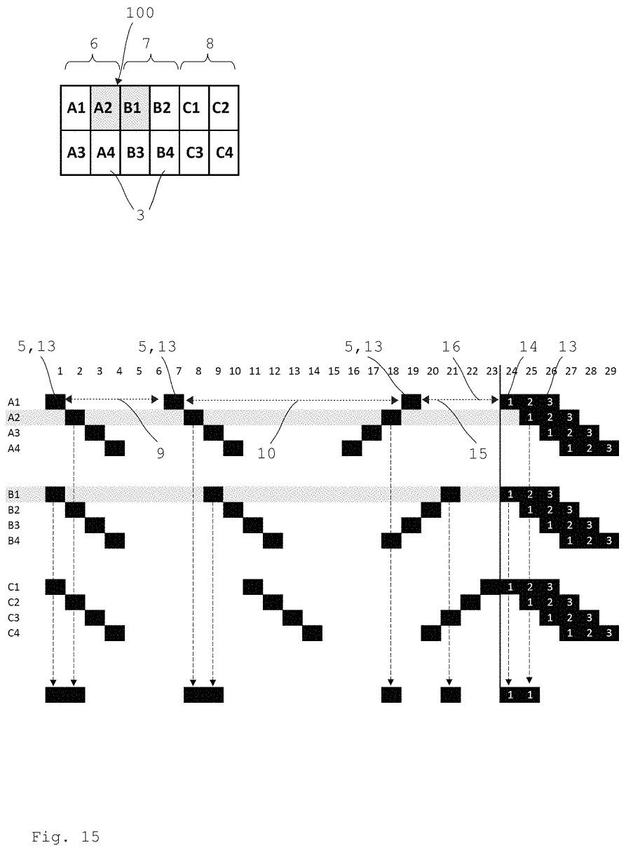

FIG. 12 shows in a purely schematic manner that, in particular when using a plurality of generator devices 6, 7, 8, the assignment signals 5 may not only be emitted in a temporally offset manner, but can also have a specific signal signature or ping signature additionally or exclusively.

In the embodiment shown here, a first generator 6 having four induction devices 3 or induction coils, a second generator 7 having four induction devices 3, and a third generator having four induction devices 3 are provided.

In order to allow a kitchen utensil 100 to be unambiguously assigned to one or more induction devices 3, both assignment signals 5 and signal signatures, which are temporally offset, are used in the embodiment shown here.

It can be seen here that a signal time curve of 23 signal blocks 12 is used, with one signal block corresponding to 10 milliseconds in this case. In each signal block, an assignment signal 5 can either be emitted or received or not.

In order to be able to distinguish between the individual induction devices 3 of the individual generators, a defined signal structure is used in the embodiment shown. Each induction device emits a predetermined sequence of electromagnetic excitations as a signature, with the signal sequences being emitted by the induction devices 3 of a generator device 6, 7, 8 in a temporally offset manner. The signal sequences each start one signal block later.

In the embodiment shown here, the predetermined sequence of electromagnetic excitations as a signature has three excitations, with a first distance 9 between the first excitation and the second excitation defining the generator device 6, 7, 8. This first distance 9 increases here from the first generator device 6 to the third generator device 8. Thus, the corresponding generator device 6, 7, 8 can be inferred via the first distance 9 between the first excitation and the second excitation of a signal sequence.

A second distance 10 defines the corresponding induction device 3 which for the sake of clarity is labelled A1, A2, A3, A4, B1, [ . . . ], C3, and C4 according to the affiliation thereof with a specific generator device 6, 7, 8.

The distance 10 from the induction device A1 to A4, B1 to B4, and Cl to C4 becomes smaller and smaller.

By means of this systematic approach, an unambiguous assignment of kitchen utensil 100 to specific induction devices can take place in the signal sequence.

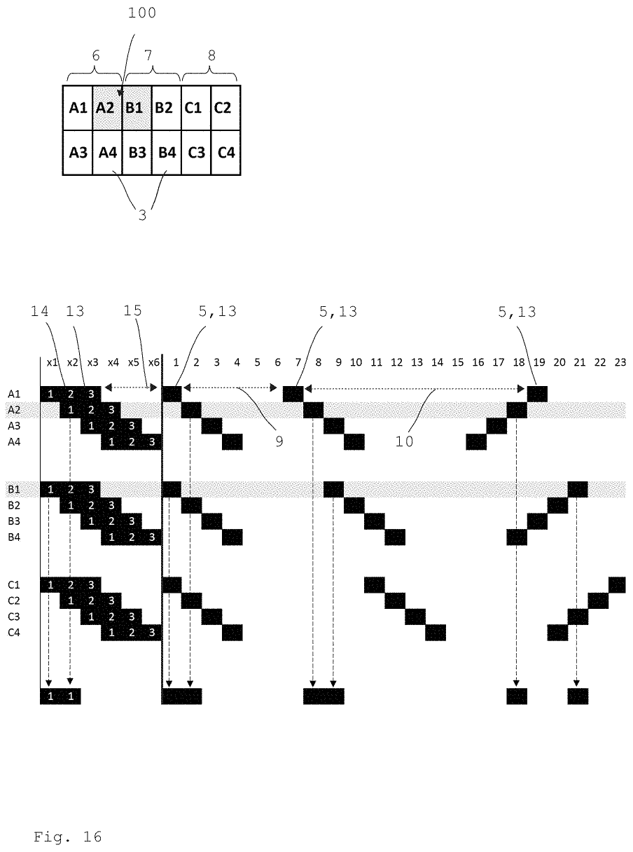

FIGS. 13 and 14 show the further processing of the determined signal sequences or signatures. In the embodiment shown, the determined signals are input into the 23 signal blocks 12 provided here, regardless of their affiliation with a specific signal sequence of a specific induction device 3.

Due to the corresponding systematic approach of the signal sequences due to the offset of the signals and the distances 9, 10 between the signals, unambiguous patterns also arise here which correspond to the covering of specific induction devices. Only multiple coverings are taken into account in FIGS. 13 and 14.

The signal pattern input in this way is converted here into an eight-digit number or identification number 11 by binary addition. Other methods can also be used to convert the pattern to an unambiguous number. This identification number 11 corresponds to a specific covering of induction devices 3 by a kitchen utensil 100.

This identification number 11 could be transmitted to the cooking hob without too high of a data volume. In the embodiment shown here, however, a table is stored in a chip in the kitchen utensil 100, in which table each identification number 11 is assigned a consecutive number which is input in the line next to the identification number 11 in FIGS. 13 and 14. In this way, the data volume during transmission from the kitchen utensil 100 to the cooking hob 1 can be reduced again.

FIG. 15 shows the functioning of the method according to the invention with a cooking system 200 according to the invention in a purely schematic manner. A cooking hob device 1 having three generator devices 6, 7, 8 is provided, each of which has four induction coils 3.

In the embodiment shown here, a kitchen utensil 100 is placed on the placement surface 2 of the cooking hob device 1 and covers the induction device A2 of the first generator device 6 and the induction device B1 of the generator device 7.

The signal encoding or the different signatures of the induction devices 3 are shown in FIG. 15 below. As already explained above, there are also three electromagnetic signals 13 which encode a specific induction device 3 as assignment signals 5. In this case, too, a first distance 9 is provided between the first assignment signal 5 and the second assignment signal which encodes a specific generator device 6, 7, 8.

A second distance 10 is provided between the second assignment signal and the third assignment signal 5, which distance encodes a specific induction device 3. Due to the fact that the starting point of the signals is not the same, each of the four induction devices 3 can be unambiguously distinguished from or assigned to the three generator devices 6, 7, 8 in the embodiment shown here.

The first distance 9 in the induction devices 3 of a generator device 6, 7, 8 is the same in the embodiment shown here and continues to increase from generator device to generator device. The different induction devices are each encoded by a smaller distance 10. The distances 10 for the respective induction devices 3 in the embodiment shown are the same for the three generator devices 6, 7, 8.

In contrast to the configurations shown above, a further signal block is provided in FIG. 15, which signal block comprises information signals 14. These information signals 14 are transmitted at a predetermined distance 15 from one of the assignment signals 5 and encode for a specific property of the cooking hob 1, of at least one generator device 6, 7, 8, and/or of at least one induction device.

In the embodiment shown here, the information signal is a fourth signal which indicates a property. Depending on the configuration, however, a plurality of information signals 14 can also be transmitted.

A third distance 16 is provided in this case between the third assignment signal 5 and the information signal 14, a specific property being encoded via the temporal distance between the last assignment signal 5 and the information signal 14.

This property can in particular be at least one state of the cooking hob device, of at least one generator device, and/or of the induction devices. It is particularly advantageous if the operating mode of the cooking hob device, of the generator, and/or of the induction devices is transmitted as a property.

The type of cooking hob device used can preferably be transmitted additionally or exclusively as a property. In particular, the information can be transmitted that a fully integrated cooking hob having a placement surface having specific properties or parameters is being used. The cooking process can then preferably be adjusted correspondingly by the kitchen utensil. However, a property can in particular also be the temperature, at least one operating parameter, a button status, the food to be prepared and/or the like.

By transmitting at least one property, for example of an induction device 1, the energy consumption of the energy store 105 or in this case of an accumulator 106 of the kitchen utensil 100 can be significantly reduced.

In the embodiment shown here, the induction devices A2 and B1 were detected via the assignment signals 5. In addition, the property “1” which is defined by the first information signal 14 was transmitted for both induction devices A2 and B1. The operating mode “preparation” is stored in the evaluation device 50 for this property, so that the frequency or the interval of the data transmission can be reduced here. This can save energy.

Depending on the configuration, different properties and/or property combinations can be stored for the information signals. In particular, speed-optimised data transmission can take place, or the frequency of data transmission can be adjusted. Depending on the configuration, situation-optimised and/or selective data transmission can also take place. Energy-optimised data transmission or signal transmission is particularly preferred.

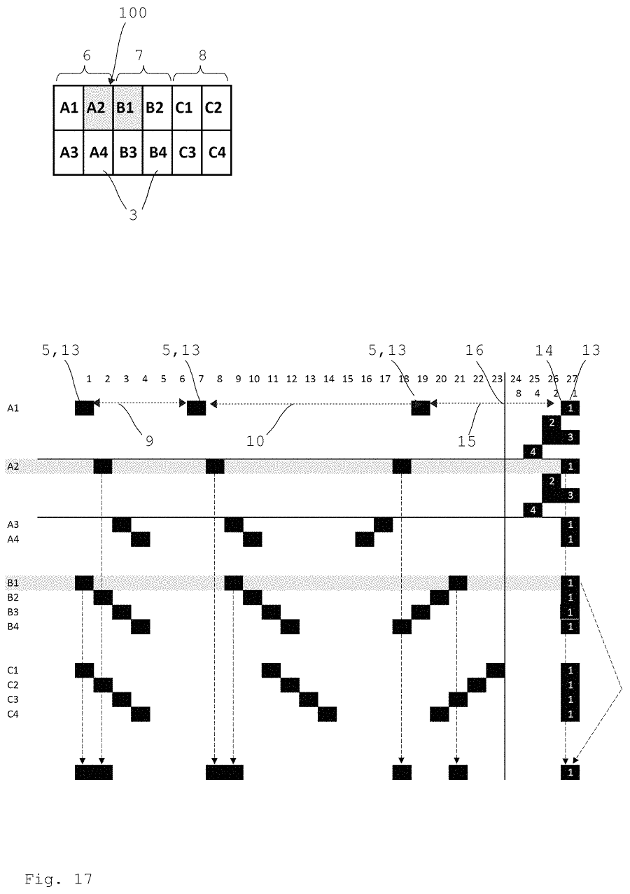

FIG. 16 shows a further embodiment of the functioning of the method according to the invention with a cooking system 200 according to the invention in a purely schematic manner. The situation corresponds to the situation described for FIG. 15. The difference from the embodiment described above is that the information signals 14 are not provided after the assignment signals 5, but rather before them.

In the embodiment shown here, information signals are first sent which encode a specific property. This is followed by the assignment signals which are used for the correct assignment of the active induction devices 3 for a kitchen utensil 100.

Depending on the configuration, however, the information signals 14 can also be sent between the assignment signals 5. In this case, however, an unnecessarily large number of electromagnetic signals 13 is generally necessary in order to form defined blocks, so that assignment signals 5 and information signals can be distinguished.

FIG. 17 shows a further embodiment in a purely schematic manner. The same situation applies here as in FIGS. 15 and 16. In contrast to the embodiments shown above, however, the information signals are encoded differently.

In this embodiment, it can happen that, when a kitchen utensil 100 covers a plurality of induction devices 3 of a generator device 6, 7, 8, a generator device 6, 7, 8 outputs two or more electromagnetic signals 13 at once.

In addition, a specific induction device 3 cannot be inferred solely from the distance 15, 16 between the information signals 14 and an assignment signal 5. An overall signal for a property is output in this case.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Cooking hob device
2 Placement surface
3 Induction device
4 Transmitting device
5 Assignment signal
6 First generator device
7 Second generator device
8 Third generator device
9 First distance
10 Second distance
11 Identification number
12 Signal block
13 Electromagnetic signal
14 Information signal
15 Temporal distance
16 Third distance
50 Evaluation device
100 Kitchen utensil
101 Receiving device
102 Coil
103 Display device
104 Base
105 Energy store
106 Accumulator/battery
200 Cooking system
300 Kitchen unit
301 Work surface

1. Method A method for operating a cooking system, comprising:
providing at least one cooking hob device, at least one kitchen utensil, and at least one evaluation device, the cooking hob device comprising at least one placement surface on which to place kitchen utensils and at least one generator device having at least two induction devices for heating the kitchen utensil placed on the placement surface, and the kitchen utensil being configured to be heated by at least one induction device;
assigning at least one transmitting device to each of the at least two induction devices of the cooking hob device, the kitchen utensil comprising at least one receiving device, each transmitting device of the at least one transmitting device emitting at least one electromagnetic signal, at least intermittently, which signal is received by the receiving device of the kitchen utensil when the kitchen utensil is heated by the corresponding induction device; using
at least one sequence of electromagnetic signals to encode a signature for a specific induction device as assignment signals, so that the kitchen utensil is assignable to at least one induction device; and
emitting at least one further electromagnetic signal as an information signal at a predetermined temporal distance from at least one of the assignment signals, the predetermined temporal distance from the assignment signal encoding a specific property.

2. The method of claim 1, wherein the electromagnetic signals of the individual transmitting devices are emitted with a predetermined temporal offset, and/or wherein the assignment signals and/or the information signals of the individual induction devices comprise different predetermined sequences of electromagnetic signals as a signature, so that the evaluation device assigns the assignment signals and/or information signals detected by the receiving device to the individual induction devices, and carries out an assignment of the kitchen utensil to at least one induction device, and/or detects at least one property of the cooking hob device, of at least one generator device, and/or of at least one induction device.

3. The method of claim 1, wherein at least one interval and/or frequency of the transmission of electromagnetic signals depend(s) at least intermittently on at least one property detected from at least one information signal.

4. The method of claim 1, wherein at least one interval and/or frequency of the transmission of electromagnetic signals depends at least intermittently on an energy state of at least one energy store.

5. The method of claim 1, wherein a cooking process is adjusted based on at least one property detected from at least one information signal.

6. The method of claim 1, wherein the assignment signals of the individual induction devices comprise same predetermined sequences of electromagnetic excitations which are distinguished via the temporal offset.

7. The method of claim 1, wherein the at least one generator device comprises at least two generator devices, and
wherein the assignment signals of the individual induction devices each comprise a predetermined sequence of at least three electromagnetic signals as a signature, a first distance between the first electromagnetic signal and the second electromagnetic signal encoding a corresponding generator device, and a second distance between the second electromagnetic signal and the third electromagnetic signal encoding the induction device of the corresponding generator device or vice versa.

8. The method claim 7, wherein the first distance increases between each generator device, and
wherein the second distance decreases from induction device to induction device of a corresponding generator device.

9. The method of claim 7, wherein the information signal as a fourth electromagnetic signal is at a third distance from the third electromagnetic signal, the third distance encoding a property of the cooking hob device, of at least one generator device, and/or of at least one induction device.

10. The method of claim 1, wherein at least two induction devices of at least one generator device simultaneously emit at least one electromagnetic signal at least once.

11. The method of claim 1, wherein the received electromagnetic signals are translated into an unambiguous identification number which corresponds to covering of specific induction devices and/or a specific property.

12. The method of claim 11, wherein the received predetermined sequences of electromagnetic signals of the corresponding induction devices are input into a common time curve, and
wherein the unambiguous identification number is determined based on a signal pattern.

13. The method of claim 1, wherein an intensity of at least one electromagnetic signal is considered.

14. The method of claim 1, wherein an intensity of the electromagnetic signals is considered in order to infer a covering of individual induction devices by a kitchen utensil.

15. A cooking system, comprising:
at least one kitchen utensil configured to be heated by at least one induction device and comprising at least one receiving device configured to receive an electromagnetic signal when the at least one kitchen utensil is heated by a corresponding induction device;
at least one cooking hob device, comprising at least one placement surface on which to place kitchen utensils and at least two induction devices configured to heat the at least one kitchen utensil placed on the placement surface;
at least one evaluation device;
at least one transmitting device assigned to each induction device of the at least two induction devices of the cooking hob device, each transmitting device of the at least one transmitting device being configured to emit at least one electromagnetic signal at least intermittently,
wherein
the evaluation device is configured to detect a signature for a specific induction device from at least one sequence of electromagnetic signals as assignment signals, so that the at least one kitchen utensil is assignable to a corresponding induction device, and
wherein the evaluation device is configured to detect at least one property of the corresponding induction device as an information signal from at least one further electromagnetic signal at a predetermined temporal distance from at least one of the assignment signals.

16. A cooking utensil, comprising:
the at least one kitchen utensil described in claim 15, wherein the at least one kitchen utensil comprises at least one energy store.

17. The cooking utensil of claim 16, wherein an interval and/or a frequency of an emission of the electromagnetic signals depend(s) on a detected property and/or an energy state of the at least one energy store.
